(19) United States
(12) Patent Application Publication
(10) Pub. No.: US 2014/0115052 A1
(43) Pub. Date: Apr. 24, 2014

(54) GENERATING MEANINGFUL NAMES FOR CONTENT USING CONTEXTUAL AND IDENTIFYING INFORMATION

(71) Applicant: PALO ALTO RESEARCH CENTER INCORPORATED, Palo Alto, CA (US)

(72) Inventors: Rebecca Lynn Braynard Silberstein, Sunnyvale, CA (US); Van L. Jacobson, Woodside, CA (US)

(73) Assignee: Palo Alto Research Center Incorporated, Palo Alto, CA (US)

(21) Appl. No.: 13/655,173

(22) Filed: Oct. 18, 2012

(51) Int. Cl. H04L 29/08

(52) U.S. Cl. CPC H04L 67/10
USPC 709/204

(57) ABSTRACT

A system can configure a peripheral device to name data using a structured name that is derived from certain contextual information. During operation, the system can detect a presence of the peripheral device, and can send a data request to the peripheral device. The data request can indicate what type of data is to be collected by the peripheral device, as well as contextual information from the local device. The system then receives a content item from the peripheral device, such that the content item includes a structured name derived from the contextual information. The system can store the content item based on the structured name.

### BACKGROUND

1. Field

This disclosure is generally related to generating a meaningful name for content. More specifically, this disclosure is related to deriving a structured name for content based on contextual information.

2. Related Art

Advances in computing technologies have resulted in digital devices entering virtually every aspect of human life. These devices exist in the form of consumer electronics, smart home appliances, and they help operate industrial equipment. Many of these devices generate data, and transfer this data to remote devices. For example, a user may take a picture using a smartphone, and may transfer the captured image to his personal computer.

Unfortunately, these peripheral devices typically assign a generic name to data. For example, a digital camera typically names images in a sequence, such that the last few characters of the image's name indicate a sequence number (e.g., “IMG_{—}0105”). If the images taken by the camera are added into a collection that includes pictures of many individuals or pictures for various events, the remote device may not be able to organize the images using their names alone.

### SUMMARY

One embodiment provides a system that configures a peripheral device to name data using a structured name that is derived from certain contextual information. During operation, the system can detect a presence of a peripheral device, and can send a data request to the peripheral device. The data request can indicate what type of data is to be collected or generated by the peripheral device, as well as contextual information from the local device. The system then receives a content item from the peripheral device, such that the content item is associated with a structured name derived from the contextual information. The system can store the content item based on the structured name.

In some embodiments, the contextual information includes one or more of: a user-identifier for a user of the personal computing device; an activity being performed by the user; an application-identifier for an application at the personal computing device; a device-identifier for the personal computing device; a geographic location or venue name for the personal computing device; a telephone number; and a timestamp.

In some embodiments, while sending the data request to the peripheral device, the system sends an encryption key to the peripheral device. Further, the content item received from the remote device includes encrypted data that has been encrypted using the encryption key.

In some embodiments, the system selects a decryption key corresponding to the encryption key, and decrypts the encrypted data of the content item using the decryption key.

In some embodiments, while storing the content item involves, the system sends the content item to a storage server that stores the content item in association with the structured name, and stores the structured name at a local content repository.

In some embodiments, while storing the content item, the system stores the content item at a local content repository so that it is associated with the structured name.

In some embodiments, the system accesses the content item from the local content repository based on the structured name.

In some embodiments, the system accesses the content item from a remote device based on the structured name. To access the content item from the remote device, the system generates an interest packet that is associated with the structured name, and broadcasts the interest packet across a computer network.

In some embodiments, the system accesses the content item based on the contextual information.

In some variations, while accessing the content item based on the contextual information, the system generates interest packet based on the contextual information, and broadcasts the interest packets across a computer network. The system can generate an interest packet, for example, by deriving a structured name from the contextual information, and generating the interest packet from the selected structured names. As another example, the system can select, from a local data repository, one or more structured names associated with the contextual information, and uses these structured names to generate the interest packets.

In some variations, while accessing the content item based on the contextual information, the system selects, from a local content repository, one or more content items whose structured names are associated with the contextual information.

One embodiment provides a system that receives contextual information from a remote device, and uses this contextual information to generate a structured name for the content items that it generates. During operation, the system can collect or generate data that is to be stored in association with the contextual information. Then, the system generates a structured name for the generated data, such that the structured name is derived from the contextual information. The system then generates a content item that includes the generated data and is associated with the structured name.

In some embodiments, the contextual information includes one or more of: a user-identifier for a user of the remote device; an activity being performed by a user of the remote device; an application-identifier for an application at the remote device; a device-identifier for the remote device; a device-identifier for the local device; a geographic location or venue name; and a timestamp.

In some embodiments, the system can receive, from a remote device, a request for data. The system then generates data for the remote device, and generates the content item for the data. Then, after generating the content item, system sends the content item to the remote device.

In some embodiments, the system uses a data-collection triggering event to determine when it needs to generate data for a collection. The data-collection triggering event can indicate one or more conditions that indicate when the system needs to generate data, and can indicate the types of data that the system is to generate. When the system detects a data-collection triggering event, the system generates data associated with the data-collection triggering event. Then, responsive to generating the content item for the generated data, the system can send the content item to a predetermined target server.

In some embodiments, when the system detects a data-collection triggering event, the system generates data associated with the data-collection triggering event. Then, responsive to generating the content item for the generated data, the system can store the content item in a local content repository.

### BRIEF DESCRIPTION OF THE FIGURES

FIG. 1 illustrates an exemplary computer system that generates content whose name is derived from contextual information in accordance with an embodiment.

FIG. 2 illustrates an exemplary communication between a client device and a peripheral device in accordance with an embodiment.

FIG. 3 presents a flow chart illustrating a method for communicating with a peripheral device to obtain content whose name is derived from contextual information in accordance with an embodiment.

FIG. 4 presents a flow chart illustrating a method for accessing content based on a context-derived structured name in accordance with an embodiment.

FIG. 5 presents a flow chart illustrating a method for accessing content based on contextual information in accordance with an embodiment.

FIG. 6 presents a flow chart illustrating a method for assigning a context-derived structured name to content generated at a peripheral device in accordance with an embodiment.

FIG. 7 presents a flow chart illustrating a method for generating content with a context-derived structured name for a remote device in accordance with an embodiment.

FIG. 8 presents a flow chart illustrating a method for generating content with a context-derived structured name in response to detecting a triggering event in accordance with an embodiment.

FIG. 9 illustrates an exemplary apparatus that facilitates generating content with a context-derived structured name in accordance with an embodiment.

FIG. 10 illustrates an exemplary computer system that facilitates generating content with a context-derived structured name in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a content-naming system that solves the problem of assigning a name to content so that the name is meaningful to a remote computing device. For example, a peripheral device, such as a digital camera, can receive contextual information or identification information from a user's personal computing device, and can use this information to name content that it generates. Other devices that know this contextual information can themselves derive the structured name to obtain the piece of content over a computer network.

The identification information can indicate a user-identifier for a user of the personal computing device, an application-identifier for an application at the personal computing device, and/or a device-identifier for the personal computing device. The contextual information can indicate an activity being performed by the user, a geographic location or venue name for the personal computing device, and/or a timestamp.

In some embodiments, by deriving a structured name for content using contextual information, the peripheral device is assigning a meaningful name to the content that can satisfy an interest in the content from other nodes in the network. This structured name is also “persistent,” which means that the content item can move around within a computing device, or across different computing devices, but the name persists with the content. Any computing device in a computer network can generate an interest in a piece of content to obtain the content from wherever it may reside. The term “persistent” also means that if the content changes, then the name changes. The new name can be automatically generated as a version of the original name, can be associated with authentication metadata (e.g., a digital signature by the publisher of the content), or can reflect the nature of the content change.

A structured name can be divided into several hierarchical components. For example, in the name “/parc/home/ccn/test.txt,” the individual name components are parc, home, ccn, and test.txt. Structured names also enable efficient routing for named content. A component-wise structure allows a hierarchical organization of names, and a logarithmic efficiency in accessing content by name. There is no single “root” for a naming scheme. However, the naming scheme can be modeled as a forest of trees. Names can be structured in various ways. For example, they can be structured in a left-oriented prefix-major fashion. For example, the name “/parc/home/ccn” can be a “parent” of “/parc/home/ccn/test.”

Name components can be binary strings and can be opaque to the underlying network. More generally, a semantic meaning to a name component is an agreement or convention between name producers and consumers. Names can also be text or in a form where low-level network nodes can understand the meaning of “special” name components. Further, a “file” is represented by a tree of content items under the file's name. For example, if various versions of the same file exist, these various versions can exist within the same prefix of the structured name.

In some embodiments, the semantic meaning of a name component can be defined by a rule that indicates which content items in a user's computer are to belong to a corresponding data collection or sub-collection. The rule can specify, for example, “all files under the ‘/share’ namespace or directory of storage drive X,” “all content items published by Adam,” and/or any rule that generates a specific set of names given to a device's content store.

In sum, the system generates a persistent structured name for a content item based on contextual information, and the associates persistent structured names with the content item. Because of this naming convention, a content item can be addressed, located, retrieved, cached, and disseminated by its name. Further, because the name is derived from contextual information, any computer can derive the persistent structured name for desired data when it knows the correct contextual information. Then, to obtain the content data that is associated with the structured name, the system can publish an interest in the structured name, and can receive the content item from any device that has the content item whose structured name satisfies the interest.

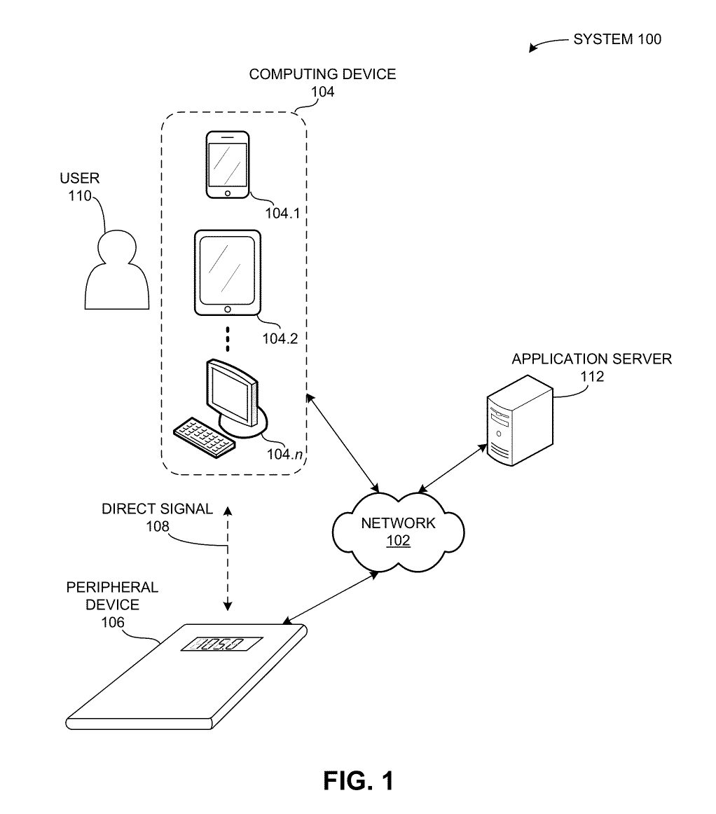

FIG. 1 illustrates an exemplary computer system 100 that generates content whose name is derived from contextual information in accordance with an embodiment. System 100 can include a computing device 104 that can communicate with a peripheral device 106 via a network 102 or a direct signal 108. Computing devices 104 can include, for example, a smartphone 104.1, a tablet 104.2, or any other personal computing device 104.n, (e.g., a desktop computer, a laptop, a home media center, etc.).

In some embodiments, device 104 can detect device 106 by detecting direct signal 108 from device 106 (e.g., a Bluetooth signal, a WiFi signal, or an RFID signal). In some other embodiments, device 104 can detect device 106 via a third-party system, such as application server 116 that informs devices 104 and 106 of their proximity to each other (e.g., based on their GPS coordinates).

A user 110 can interact with peripheral device 106 directly, or via computing device 104. For example, peripheral device 106 can include a weighing scale, which activates when user 110 steps onto the weighing scale. User 110 can then interact with an application running on computing device 104 to request a weight reading from peripheral device 106. Computing device 104 can send contextual information to peripheral device 106 (e.g., via network 102, or via direct signal 108), and peripheral device 106 uses this contextual information to derive a structured name for a content item that includes the weight reading.

Because the content item is associated with a persistent structured name, the content item belongs to a data collection associated with a domain for this structured name. This makes the content item accessible from anywhere in network 102. Application server 112 can obtain the content item by broadcasting an interest that includes the structured name, or includes a subset of the structured name, without first determining a network address for computing device 104. Further, if peripheral device 106 stores the content item at application server 112, computing device 104 can obtain the content item from application server 112 by broadcasting the corresponding interest packet, without having to determine a network address for application server 112.

In some embodiments, computing device 104 includes a repository that stores a plurality of structured names and/or content items. Computing device 104 can use a structured name to broadcast an interest packet for a desired content item (e.g., if the repository does not store the corresponding content item), or to satisfy a request that includes an interest packet (e.g., if the repository stores the corresponding content item).

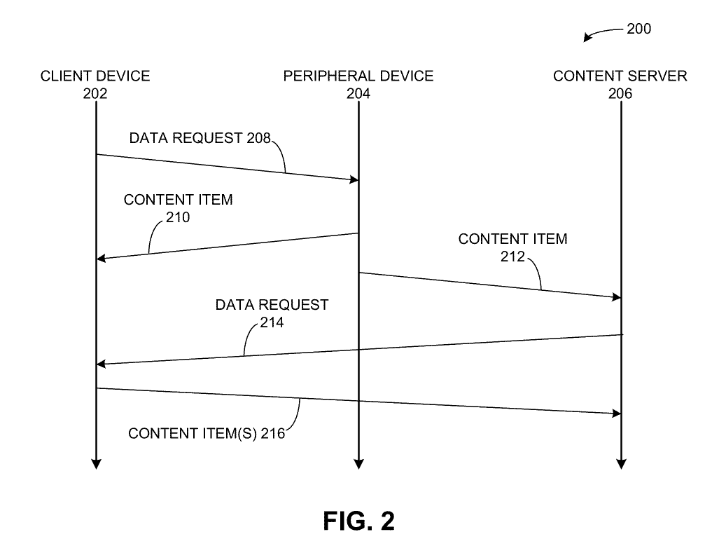

FIG. 2 illustrates an exemplary communication 200 between a client device 202 and a peripheral device 204 in accordance with an embodiment. During operation, client device 202 can send a data request 208 to peripheral device 204, which includes contextual information, and can indicate a type of information being requested. Then, peripheral device 204 generates data to satisfy the request, and sends a content item 210 that includes this data and has a meaningful structured name that is derived from the contextual information.

In some embodiments, client device 202 can send request 208 to configure peripheral device 204 to provide configuration information to peripheral device 204, which peripheral device 204 then uses derive a meaningful name for any data that it generates. This configuration information can include contextual information related to peripheral device 204, such as a device name, a geographic location or venue name, etc. Peripheral device 204 can generate data periodically (e.g., at timed intervals), or in response to detecting an event (e.g., based on criteria within a rule). Once peripheral device 204 generates data, it can create a content item 212 that includes the data and is associated with a meaningful structured name, and can store content item 212 in a local repository, or can provide content item 212 to a content server 206.

In some embodiments, client device 202 can also provide one or more content items 216 to content server 206. For example, client device 202 may store a plurality of content items within a repository at content server 206 (e.g., a backup server). As another example, client device 202 may receive an interest packet 214 from a content server 206 of an entity that provides a service to the user (e.g., a fitness trainer, a doctor, etc.). The interest packet can include a structured name for information about the user (e.g., health information related to the user). In response to receiving interest packet 214, client device 202 can send content items 216, which include the requested information, to content server 206.

### Personal Computing Device

In some embodiments, a user can use a personal computing device (e.g., a smartphone) to provide contextual information to a peripheral device. The peripheral device can use this contextual information to derive a meaningful structured name for a content item that it generates.

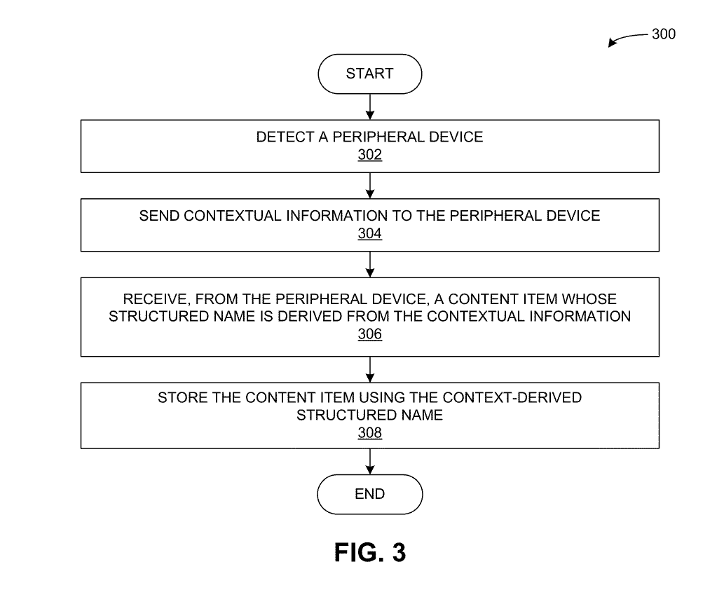

FIG. 3 presents a flow chart illustrating a method 300 for communicating with a peripheral device to obtain content whose name is derived from contextual information in accordance with an embodiment. During operation, the peripheral device (e.g., a weight scale, a light fixture, etc.) can advertise its presence over a wired or wireless network (e.g., a Bluetooth or Wi-Fi wireless network, or an Ethernet local area network (LAN)). The system can detect this presence advertisement (operation 302), and can communicate with the peripheral device over this network.

In some embodiments, the system can send contextual information to the peripheral device (operation 304), which configures the peripheral device to name content in a meaningful way. For example, the peripheral device can be a network-enabled light fixture that can send status updates to a predetermined target server. The system can provide the peripheral device with contextual information about the peripheral device, which the peripheral device then uses to generate a structured name for the status update that is meaningful to the target server.

The contextual information can include a geographic or venue location for the peripheral device (e.g., a business name, an address, a building name, and/or a room number). The contextual information can also indicate an identifier for the peripheral device (e.g., a part number, and/or inventory number), and/or membership information for the peripheral device (e.g., a group identifier assigned to a set of light fixtures within a specific room). Thus, when the peripheral device has a new status update for the target server (e.g., a detected ambient light level, a detected motion, or a malfunctioning or degraded light source of the light fixture), the peripheral device can generate a meaningful structured name derived from the peripheral device's contextual information. The peripheral device can package the status update into a content item that is associated with the meaningful structured name, and can provide this content item to the target server.

As another example, the peripheral device can be any device that generates data for the user's personal computing device, such as a weight scale, an exercise machine, a digital camera, etc. During operation 304, the system can send a request that includes the contextual information, and can indicate the type of data being requested (e.g., body weight, heart rate, estimated body mass index (BMI), etc.). The contextual information can indicate any information that identifies the user, the user's personal computing device, and/or an activity being performed by the user (e.g., a geographic location, a venue name, an activity description, etc.). The system then receives a content item that includes the requested data and has a structured name derived from the contextual information (operation 306). The system stores the content item using the context-derived structured name (operation 308), for example, in a local repository or at a remote server.

In some embodiments, the peripheral device can be a publicly accessible device. For example, the peripheral device may be a weighing scale or exercise equipment at a public gym. Thus, during operation 304, the system provides to the peripheral device contextual information that does not include information that is sensitive to the user. Further, the system can use public-key cryptography to perform secure communication with the peripheral device. During operation 304, the system can generate the request so that it includes a public encryption key for the peripheral device to use to encrypt the data it generates. Then, when the system receives the content item from the peripheral device, the system can use a corresponding private decryption key to decrypt the data embedded in the content item.

Accessing Content from the Personal Computing Device

In some embodiments, the system can access content items generated by the peripheral device based on their structured names. The structured name may be unique to a certain piece of data (e.g., a specific value obtained at a specific date from a weighing scale at the gym), or may indicate a domain for a collection of content items (e.g., a history of weight values that have been received from the weighing scale at the gym).

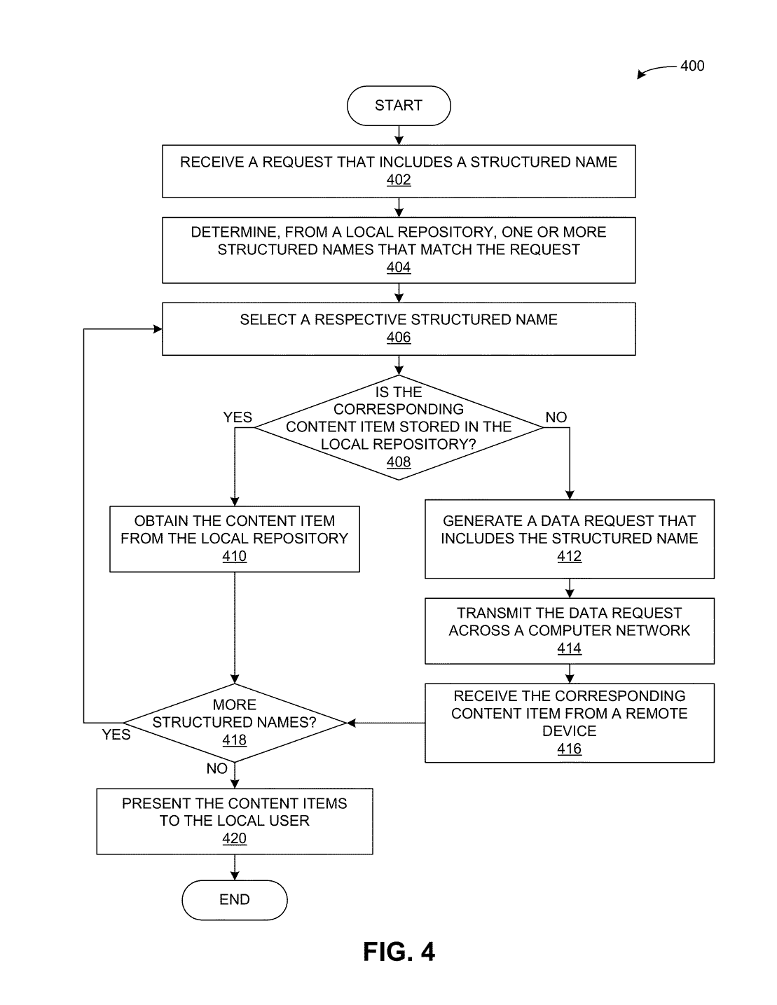

FIG. 4 presents a flow chart illustrating a method 400 for accessing content based on a context-derived structured name in accordance with an embodiment. During operation, the system can receive a request that includes a structured name (operation 402). The system can use this structured name to determine, from a local repository, one or more structured names that match the request (operation 404).

Recall that the system may use a local repository to store the structured names for the data that it receives from the peripheral device, but may store the content items within a collection at a remote server. The local repository can store some content items from the collection (e.g., recent content items), and other content items from the collection can be obtained from remote devices. To obtain the content items associated with the determined structured names, the system can select a respective structured name (operation 406), and determines whether the corresponding content item is stored in the local repository (operation 408).

If the corresponding content item is stored in the local repository, the system can obtain the content item from the local repository (operation 410). Otherwise, the system generates an interest packet that includes the structured name (operation 412), and broadcasts the interest packet across a computer network (operation 414). Once the interest packet propagates to a remote network device that includes the content item (e.g., a storage server or another computing device owned by the user), the system receives the content item from the remote device (operation 416).

The system then determines if there are more structured names (operation 418). If so, the system returns to operation 406 to select another structured name. Otherwise, the system can present to the user the content items that match the request's structured name (operation 420).

In some embodiments, the system can access content items that it has received from the peripheral device based on contextual information. The contextual information can include any information that the peripheral device uses to generate a structured name for content. For example, the contextual information can include information about the peripheral device, such as a device name, device identifier, a location or venue for the device, etc. As another example, the contextual information can include any information that identifies the user, the user's personal computing device, a date or date range, and/or an activity being performed by the user (e.g., a geographic or venue location, an activity description, etc.). The system can use this contextual information to generate a structured name that corresponds to one or more content items in a collection.

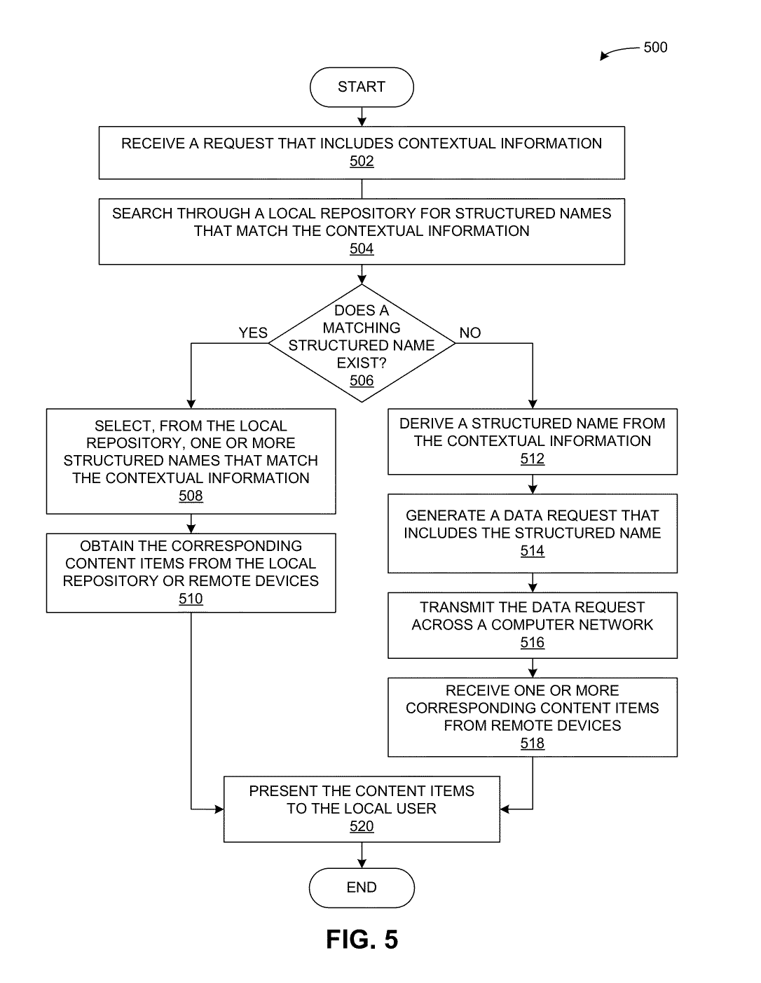

FIG. 5 presents a flow chart illustrating a method 500 for accessing content based on contextual information in accordance with an embodiment. During operation, the system can receive a request that includes contextual information (operation 502). The system can use this contextual information to search through a local repository for structured names that match the contextual information (operation 504), and determines whether at least one matching structured name exists (operation 506).

If the system does not find a matching structured name, the system derives a structured name from the contextual information (operation 512), and generates an interest packet that includes the structured name (operation 514). The system then broadcasts the interest packet across a computer network (operation 516), and receives one or more corresponding content items from remote devices that have stored the content item (operation 518). The system then presents the content items to the local user (operation 520).

However, if the system does find a matching structured name, the system selects one or more structured names from the local repository that match the contextual information (operation 508), and obtains the corresponding content items from the local repository or from one or more devices (operation 510). Recall that the local repository can store structured names for a collection of content items in the local repository, and can store the corresponding content item in the local repository and/or at a remote device. For example, the system may only store a subset of the collection in the local repository, and broadcasts an interest packet that includes the structured name across the network to obtain the content item from a remote device. Once the system obtains the corresponding content items, the system can proceed to operation 520 to present these content items to the user.

In some embodiments, the local repository may not include a complete set of structured names that match the contextual information. For example, the user may own multiple personal computing devices that he uses to obtain data from the peripheral device. The user may alternate between using a smartphone, a laptop, a portable music player, and/or a portable game system to interact with various peripheral devices (e.g., weighing scales at a gym, at a doctor's office, or at home). Thus, to ensure that the system obtains a complete collection of content items that match the request's contextual information, the system can determine structured names for the desired content items by both deriving structured names from the contextual information (operation 512) and selecting the matching structured names from the local repository (operation 508).

### Peripheral Device

In some embodiments, the peripheral device can generate a plurality of structured names and content items for each piece of contextual information that it receives. For example, the peripheral device can be an appliance (e.g., a light fixture) that can send status updates to a technician or a remote repository. The peripheral device can receive contextual information associated with the peripheral device, for example, from the technician's mobile device. Then, when the peripheral device generates a status update, the system can derive a meaningful structured name for the status update using the contextual information. The peripheral device may receive the contextual information once (e.g., indicating a location of the peripheral device), and can re-use this contextual information each time it generates a status update. In some embodiments, the peripheral device can also receive updated contextual information that replaces or updates a portion of the previous contextual information (e.g., a date, a new location, etc.).

In some embodiments, the peripheral device can generate a plurality of structured names for each piece of data that it generates. For example, the peripheral device can be a camera at a public venue, such as within an amusement park or at the finish line of a marathon. The peripheral device can receive contextual information from a plurality of user smartphones at around the time that it generates a new piece of content (e.g., within a determinable time period before and after generating the content). This contextual information can originate from users on a roller coaster, users running in front of the camera at the marathon, or users inside a photo kiosk. Each piece of contextual information identifies a different user, and can also include a public encryption key for that user. Thus, each time the camera takes a picture, the camera can generate a content item for each person in the picture. Each content item can have a different structured name associated with a specific user (based on the user's contextual information), and the image can be encrypted using that user's public encryption key. The camera can upload this content item to a publicly available repository, which allows each user to obtain his or her pictures at a later date using an interest packet that includes a structured name derived from his or her contextual information.

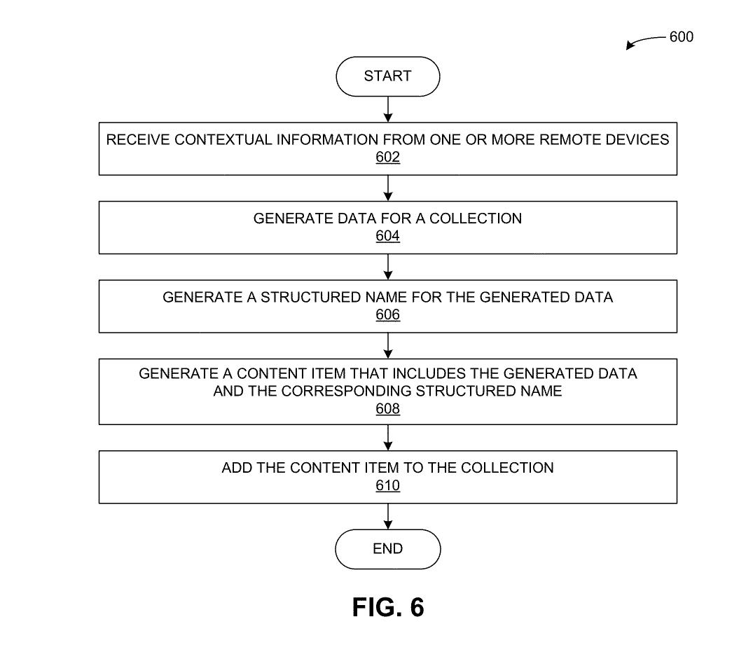

FIG. 6 presents a flow chart illustrating a method 600 for assigning a context-derived structured name to content generated at a peripheral device in accordance with an embodiment. During operation, the system receives contextual information from a remote device (operation 602), and generates data for a collection (operation 604). The system then uses the contextual information to generate a structured name for the generated data (operation 606), and generates a content item that includes the generated data and is associated with the structured name (operation 608). The system then adds the content item to the collection (operation 610).

In some embodiments, the peripheral device may generate data in response to receiving a request from a user's personal computing device, and can provide this data back to the user's personal computing device. The peripheral device may be a device within a public setting, and can be accessed by any device over a public or local area network (e.g., a Bluetooth or Wi-Fi network).

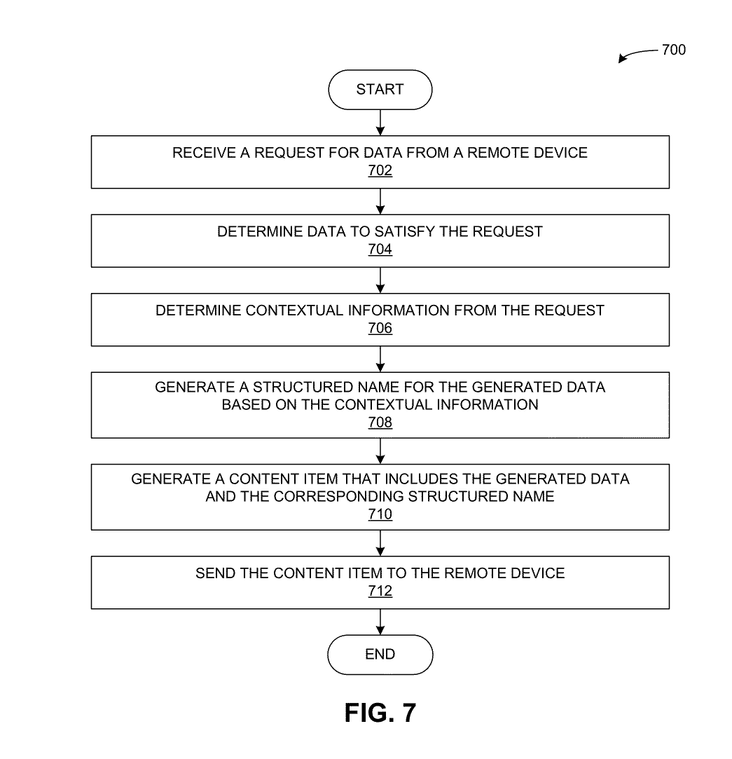

FIG. 7 presents a flow chart illustrating a method 700 for generating content with a context-derived structured name for a remote device in accordance with an embodiment. During operation, the system receives a request for data from a remote device (operation 702), and generates data to satisfy the request (operation 704).

The system then determines contextual information from the request (operation 706), and generates a structured name for the generated data based on the contextual information (operation 708). To generate the structured name, the system can follow a predetermined naming scheme that indicates which pieces of contextual information are mapped to which sections of the structured name. For example, the naming scheme may specify:

“/Application/Name/Location/Activity/UserDevice/Data” (1)

In naming scheme (1), “Application” indicates an application within the user's personal computing device that is interacting with the peripheral device. “Name” indicates the user's name, and “UserDevice” indicates an identifier for the user's device. The system can obtain values for “Application” “Name” and “UserDevice” from the user's contextual information. “Location” can indicate a geographic location or venue name, and can “Activity” indicate an activity that the user is performing (e.g., exercising at the gym, running on a treadmill, at a doctor's visit, etc.). The system can obtain values for “Location” and “Activity” either from the user's contextual information or from information pre-programmed into the peripheral device.

“Data” can indicate an identifier for the type of data that was generated, and/or any other information. For example “Data” can indicate the user's weight (from a weighing scale), the user's performance data (e.g., from a treadmill or an exercise bike), a timestamp, etc. These values can exist at a single hierarchy level for the structured name (e.g., “/weight_{—}14Jan2012”), or can be broken down into multiple hierarchy levels (e.g., “/weight/14Jan2012”). In some embodiments, “Data” can also indicate an identifier for the peripheral device, which allows the user to compare data values obtained from the same device, in case the user obtains data form various devices that are calibrated differently.

Once the system generates the structured name, the system generates a content item that includes the generated data and is associated with the corresponding structured name (operation 710), and sends this content item to the remote device (operation 712). In some embodiments, the request from the user's device can also include a public encryption key. The system can use this encryption key to encrypt the generated data, and can generate the content item to include the encrypted data. This allows the peripheral device to protect content that is sensitive to the user, such as health-related information (e.g., a weight reading), a picture or video of the user, etc.

In some embodiments, the peripheral device may generate data in response to detecting a trigger event, and can add this data to a predetermined collection. The peripheral device may be any network-enabled device, such as a home automation system, a component of the home automation system (e.g., a light fixture), an industrial appliance, a personal computing device, etc. The peripheral device may store one or more rules that indicate when it needs to collect or generate data for the collection. Each rule can indicate trigger criteria for a trigger event, and can also indicate a type of data that the system is to collect or generate.

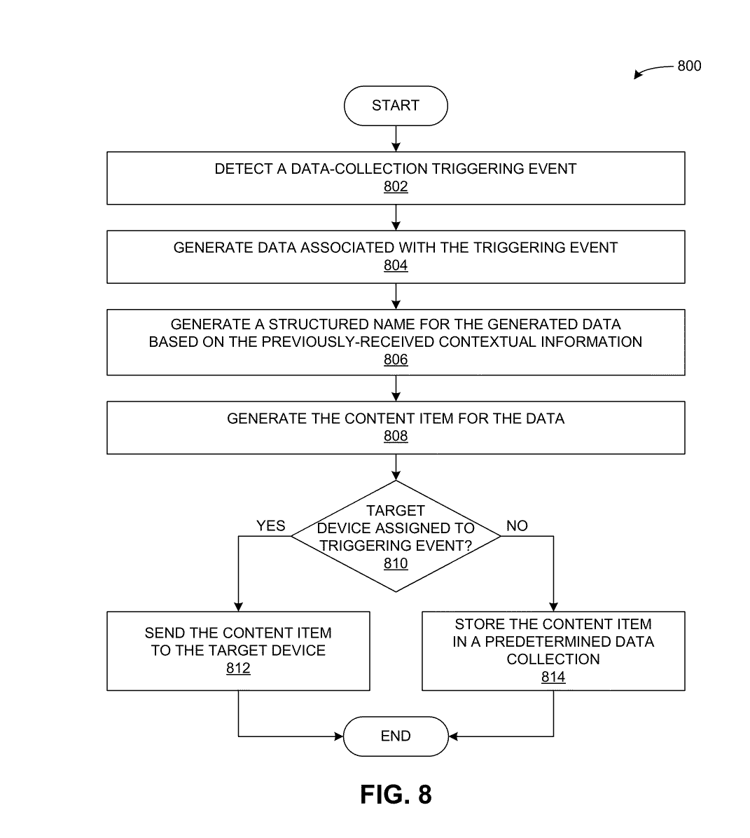

FIG. 8 presents a flow chart illustrating a method 800 for generating content with a context-derived structured name in response to detecting a triggering event in accordance with an embodiment. During operation, the system can detect a data-collection triggering event (operation 802), and generates data associated with the triggering event (operation 804). For example, the system may periodically collect state information for the peripheral device, and compares one or more data values from the state information to the trigger criteria of each rule. If the system determines that a rule's trigger criteria is met, the system can determine the data that it needs to collect based on the triggered rule. This data may include a subset of the state information, and/or may include other data that the system needs to collect or generate.

Recall that the system can receive contextual information from a remote device (e.g., operation 602 of FIG. 6), which the system can use to generate a meaningful structured name for the data it generates. After the system generates the data, the system generates a structured name for the data based on the previously received contextual information (operation 806). The system uses this structured name to generate a content item that includes the generated data and is associated with the structured name (operation 808).

In some embodiments, some rules can assign a target device that is to receive data corresponding to a given trigger event. After the system generates the content item, the system determines whether the trigger event is assigned a target device (operation 810). If so, the system can send the content item to the target device (operation 812). For example, a network-enabled streetlight fixture whose light source is becoming dim or has broken can inform a technician by sending content item that includes this information to the technician's computer system (or to a database accessible by the technician). If the worker receives status updates from a plurality of light fixtures, the technician can filter these status updates based on their meaningful structured names. For example, the structured name may indicate a neighborhood for a light fixture, which allows the technician to determine which nearby light fixtures need fixing while the technician is within a given neighborhood.

However, if the triggering event is not assigned a target device, the system can store the content item in a predetermined data collection (operation 814). This predetermined data collection may be stored locally, or at a predetermined storage device. Continuing with the example for a streetlight fixture, a technician can determine status updates for a given neighborhood by using his personal computing device to broadcast an interest packet for the desired information. The technician's device can select contextual information for that neighborhood (e.g., the neighborhood's name or geographic location) or for a given light fixture (e.g., an assigned name or identifier for the light fixture), and can generate a meaningful structured name from this contextual information. Then, by broadcasting an interest packet that has this structured name, the user's device is configuring the computer network to propagate the interest packet to any computing node for a data collection associated with the structured name. This allows the technician to receive the relevant information, regardless of where the information is stored.

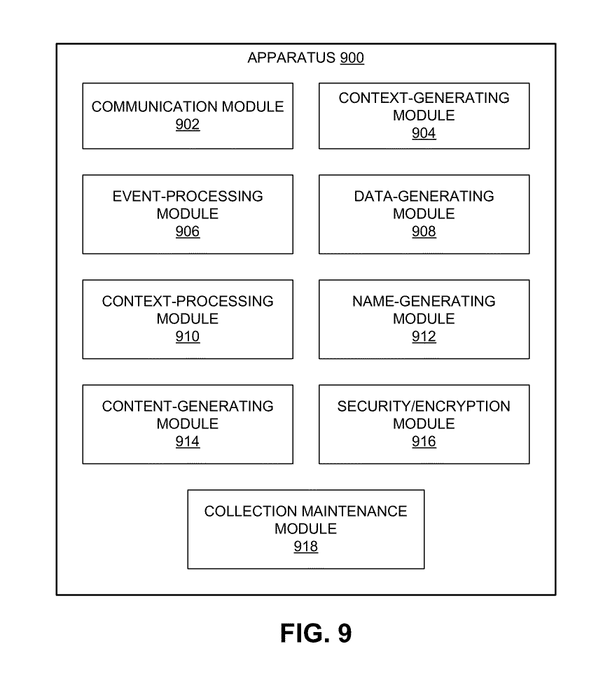

FIG. 9 illustrates an exemplary apparatus 900 that facilitates generating content with a context-derived structured name in accordance with an embodiment. Apparatus 900 can comprise a plurality of modules which may communicate with one another via a wired or wireless communication channel. Apparatus 900 may be realized using one or more integrated circuits, and may include fewer or more modules than those shown in FIG. 9. Further, apparatus 900 may be integrated in a computer system, or realized as a separate device which is capable of communicating with other computer systems and/or devices. Specifically, apparatus 900 can comprise a communication module 902, a context-generating module 904, an event-processing module 906, a data-generating module 908, a name-generating module 912, a content-generating module 910, and a collection maintenance module 914.

In some embodiments, communication module 902 can send and/or receive contextual information, and can send and/or receive a content item that has a structured name associated with the contextual information. Context-generating module 904 can generate the contextual information to include information about a local device, a local user, and/or an activity being performed by the local user. Event-processing module 906 can detect a data-collection triggering event, which indicates a type of data to collect or generate. Data-generating module 908 can generate the data associated with the data-collection triggering event. Name-generating module 910 can derive a structured name for the data based on the contextual information. Content-generating module 912 can generate a content item for the data, such that the content item includes the data and is associated with the structured name. Collection maintenance module 914 can add the content item to a corresponding data collection based on the content item's structured name.

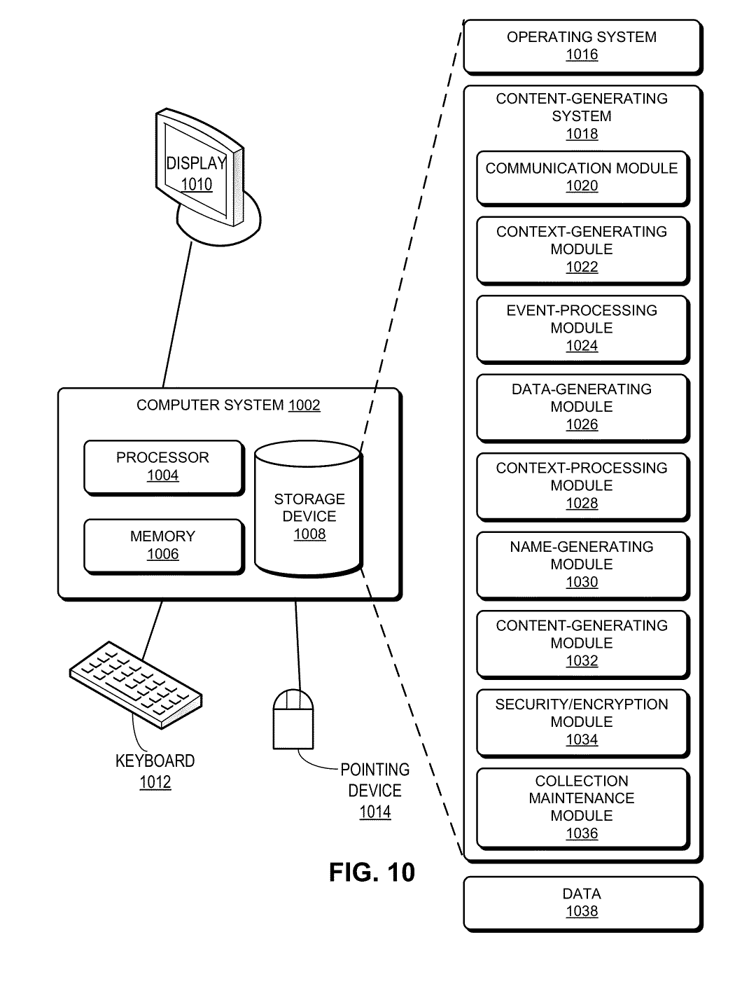

FIG. 10 illustrates an exemplary computer system 1000 that facilitates generating content with a context-derived structured name in accordance with an embodiment. Computer system 1002 includes a processor 1004, a memory 1006, and a storage device 1008. Memory 1006 can include a volatile memory (e.g., RAM) that serves as a managed memory, and can be used to store one or more memory pools. Furthermore, computer system 1002 can be coupled to a display device 1010, a keyboard 1012, and a pointing device 1014. Storage device 1008 can store operating system 1016, a content-generating system 1018, and data 1034.

Content-generating system 1018 can include instructions, which when executed by computer system 1002, can cause computer system 1002 to perform methods and/or processes described in this disclosure. Specifically, content-generating system 1018 may include instructions for sending and/or receiving contextual information, and sending and/or receiving a content item that has a structured name associated with the contextual information (communication module 1020). Further, content-generating system 1018 can include instructions for generating the contextual information to include information about a local device, a local user, and/or an activity being performed by the local user (context-generating module 1022). Content-generating system 1018 can also include instructions for detecting a data-collection triggering event, which indicates a type of data to collect or generate (event-processing module 1024).

Content-generating system 1018 can also include instructions for generating the data associated with the data-collection triggering event (data-generating module 1026). Content-generating system 1018 can also include instructions for deriving a structured name for the data based on the contextual information (name-generating module 1028). Content-generating system 1018 can also include instructions for generating a content item for the data, such that the content item includes the data and is associated with the structured name (content-generating module 1030). Content-generating system 1018 can also include instructions for adding the content item to a corresponding data collection based on the content item's structured name (collection-maintenance module 1032).

Data 1034 can include any data that is required as input or that is generated as output by the methods and/or processes described in this disclosure. Specifically, data 1034 can store at least contextual information for a user, a plurality of data-collection trigger events, data and content items that have been generated for the user, and/or one or more collections of content items.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
detecting, by a personal computing device, a presence of a peripheral device;
sending a data request to the peripheral device, wherein the data request includes contextual information from the personal computing device;
receiving a content item from the peripheral device, wherein the content item is associated with a structured name derived from the contextual information; and
storing the content item based on the structured name.

2. The method of claim 1, wherein the contextual information includes one or more of:
a user-identifier for a user of the personal computing device;
an activity being performed by the user;
an application-identifier for an application at the personal computing device;
a device-identifier for the personal computing device;
a geographic location for the personal computing device;
a telephone number;
a timestamp.

3. The method of claim 1, wherein sending the data request to the peripheral device further comprises sending an encryption key to the peripheral device; and
wherein the received content item includes encrypted data that has be encrypted using the encryption key.

4. The method of claim 3, further comprising:
selecting a decryption key corresponding to the encryption key; and
decrypting the encrypted data of the content item using the decryption key.

5. The method of claim 1, wherein storing the content item involves:
sending the content item to a storage server that stores the content item in association with the structured name; and
storing the structured name at a local content repository.

6. The method of claim 1, wherein storing the content item involves storing the content item at a local content repository so that it is associated with the structured name.

7. The method of claim 6, further comprising accessing the content item from the local content repository based on the structured name.

8. The method of claim 1, further comprising accessing the content item from a remote device based on the structured name, wherein accessing the content item involves:
generating an interest packet that includes the structured name; and
broadcasting the interest packet across a computer network.

9. The method of claim 1, further comprising accessing the content item based on the contextual information.

10. The method of claim 9, wherein accessing the content item based on the contextual information involves:
generating an interest packet based on the contextual information; and
broadcasting the interest packet across a computer network.

11. The method of claim 9, wherein accessing the content item based on the contextual information involves selecting, from a local content repository, one or more content items whose structured names are associated with the contextual information.

12. A non-transitory computer-readable storage medium storing instructions that when executed by a computer cause the computer to perform a method, the method comprising:
detecting a presence of a peripheral device;
sending a data request to the peripheral device, wherein the data request includes contextual information associated with a user or the user's personal computing device;
receiving a content item from the peripheral device, wherein the content item is associated with a structured name derived from the contextual information; and
storing the content item based on the structured name.

13. The storage medium of claim 12, wherein storing the content item involves:
sending the content item to a storage server that stores the content item in association with the structured name; and
storing the structured name at a local content repository.

14. The storage medium of claim 12, wherein storing the content item involves storing the content item at a local content repository so that it is associated with the structured name.

15. The storage medium of claim 14, further comprising accessing the content item from the local content repository based on the structured name.

16. The storage medium of claim 12, further comprising accessing the content item based on the contextual information.

17. A computer-implemented method, comprising:
receiving, by a local computing device, contextual information from a remote device;
responsive to generating data at the local computing device, generating a structured name for the data, wherein the structured name is derived from the contextual information; and
generating a content item that includes the generated data and is associated with the structured name.

18. The method of claim 17, wherein the contextual information includes one or more of:
a user-identifier for a user of the remote device;
an activity being performed by a user of the remote device;
an application-identifier for an application at the remote device;
a device-identifier for the remote device;
a device-identifier for the local device;
a geographic location; and
a telephone number;
a timestamp.

19. The method of claim 17, further comprising:
receiving, from a remote device, a request for data;
generating data for the remote device; and
responsive to generating the content item for the data, sending the content item to the remote device.

20. The method of claim 17, further comprising:
detecting a data-collection triggering event;
generating data associated with the data-collection triggering event; and
responsive to generating the content item for the data, sending the content item to a predetermined target server.

21. The method of claim 17, further comprising:
detecting a data-collection triggering event;
generating data associated with the data-collection triggering event; and
responsive to generating the content item for the data, storing the content item in a local content repository.

22. An apparatus, comprising:
a communication module to receive contextual information from a remote device;
a data-generating module to generate data;
a name-generating module to generate a structured name for the data, wherein the structured name is derived from the contextual information; and
a content-generating module to generating a content item that includes the generated data and is associated with the structured name.

23. The apparatus of claim 22, wherein the communication module is further configured to:
receive, from the remote device, a request for data; and
send the content item to the remote device responsive to the content-generating module generating the content item for the remote device.

24. The apparatus of claim 22, further comprising an event-processing module to:
detect a data-collection triggering event;
configure the data-generating module to generate data associated with the data-collection triggering event; and
configure the communication module to send the content item to a predetermined target server responsive to the content-generating module generating the content item for the data.

25. The apparatus of claim 22, further comprising:
an event-processing module to:
detecting a data-collection triggering event; and
configure the data-generating module to generate data associated with the data-collection triggering event; and
a collection maintenance module to store the content item in a local content repository responsive to the content-generating module generating the content item for the data.
